(19) United States
(12) Patent Application Publication
(10) Pub. No.: US 2009/0196148 A1
(43) Pub. Date: Aug. 6, 2009

(54) MASTER RECORDING APPARATUS AND MASTER RECORDING METHOD

(75) Inventors: Keiichiro YUSU, Yokohama-shi (JP); Masahiro SAITO, Yokohama-shi (JP); Kazuto KURODA, Yokohama-shi (JP); Takashi USUI, Yokohama-shi (JP); Kazuo WATABE, Yokohama-shi (JP); Chosaku NODA, Yokohama-shi (JP); Nobuaki KAJI, Yokohama-shi (JP); Masaaki MATSUMARU, Funabashi-shi (JP); Ryosuke YAMAMOTO, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/362,322

(22) Filed: Jan. 29, 2009

(30) Foreign Application Priority Data
Jan. 31, 2008 (JP) 2008-021414

(51) Int. Cl. G11B 7/135

(52) U.S. Cl. 369/112.01; G9B/7

(57) ABSTRACT

According to one embodiment, the invention provides a master recording apparatus and method which can form a pit having a symmetrical pit shape with excellent reproducibility. An embodiment of the invention is a master recording apparatus where a resist film on a master for an optical disk is irradiated with irradiation light from a semiconductor laser to record information on the resist film, where the resist film is formed as an inorganic resist film, and means for outputting the irradiation light from the semiconductor laser as a short pulse laser with a pulse width between 200 ps and 1 ns is provided.

### CROSS-REFERENCE TO RELATED APPLICATIONS

This application is based upon and claims the benefit of priority from Japanese Patent Application No. 2008-021414, filed Jan. 31, 2008, the entire contents of which are incorporated herein by reference.

### BACKGROUND

1. Field

One embodiment of the present invention relates to a master recording apparatus and a master recording method for manufacturing a master used for manufacturing an optical disk. In particular, the present invention is suitable for application to an apparatus for manufacturing a master for manufacturing an optical disk as a high-density recording medium.

2. Description of the Related Art

Conventionally, a master for an optical disk is manufactured according to the following steps. Photosensitive photoresist material is first applied at a uniform film thickness to a glass or Si disk which is a base disk. Thereafter, the photoresist material is irradiated with laser with a desired beam diameter in order to record digital information so that portions on the photosensitive material configuring information pits are subjected to photosensitization. When the base disk having the whole surface recorded is immersed in alkaline developer, the photosensitized portions are eluted so that recessed pits are formed. The base disk thus formed is used as a master for an optical disk, and an optical disk is provided through a stamper manufacturing step, an injection molding step, and a disk manufacturing step.

Incidentally, the optical disks can be classified to CD standard and digital versatile disk (DVD) standard according to recording capacities. Especially, for recording video and audio (music data), the DVD standard, and HD DVD and Blu-ray disk (BD) standard obtained by further developing the DVD standard are widely used in view of their recording capacities.

The minimum pit size on a master for an optical disk manufactured in the abovementioned method depends on a wavelength of a light source and an objective lens NA due to use of the photoresist. Therefore, it is necessary to use shorter wavelength and higher NA in order to produce smaller pits for larger capacity, but it is necessary to use ultraviolet region laser or electron beam having a wavelength of 400 nm or lower in order to achieve a large capacity equal to or more than a capacity of the current DVD. However, such an apparatus is thought to be unrealistic because it is very expensive, it is narrow regarding a manufacture margin, and a limit occurs in miniaturization of the photosensitive portion.

In recent years, PTM (Phase Transition Mastering: Ref. “High resolution Blue Laser Mastering with Inorganic Photo-resist”, Technical Digest of ISOM/ODS 2002, p 27) using heat-sensitive type inorganic resist material has been put in a practical use in order to overcome the optical limit. However, the PTM technology still leaves a problem for practical use because a pit shape margin to recording power is narrow and many trial manufactures for obtaining conditions for manufacturing a master having excellent signal characteristics with excellent reproducibility must be performed.

As a technique for a manufacturing apparatus of a master, there is one disclosed in Patent Document 1 (Jpn. Pat. Appln. KOKAI Publication No. 2001-250279). The technique disclosed in Patent Document 1 includes a step of forming a heat-sensitive material layer and a step of irradiating the heat-sensitive material layer with laser light to form a metamorphosed portion of a pattern corresponding to a fine convexo-concave pattern. When the metamorphosed portion is formed, laser light is intensity-modulated according to a targeted fine convexo-concave pattern. In this case, the laser light is modulated utilizing constant high-frequency signal with, for example, a frequency of 100 MHz higher than a frequency of a recording data signal. The metamorphosed portion is, for example, removed by development, so that the heat-sensitive material layer is formed in a fine convexo-concave pattern.

However, the technique is a manufacturing technique of a low density recording medium and miniaturization of pits is demanded in order to achieve further high density. In this case, in the conventional method, such a problem arises that a pit shape tends to be distorted and signal quality deteriorates.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an illustration diagram showing a relationship between a record pattern and a laser diode output pulse for explaining a recording method in a master recording apparatus according to the present invention;

FIG. 2 is an illustration diagram showing a relationship between a beam spot and a temperature profile of a beam irradiation section for explaining an operation of the master recording apparatus according to the present invention;

FIG. 3 is a pattern diagram showing a pit shape on a master obtained according to a conventional method and a pit shape on a master obtained by the method according to the present invention in a comparison manner;

FIG. 4 is a schematic configuration diagram of the master recording apparatus according to the present invention;

FIG. 5 is a configuration explanatory diagram before working a master according to one example of the present invention;

FIG. 6 is a configuration explanatory diagram before working a master according to another example of the present invention;

FIG. 7 is a diagram showing a specific example of a short pulse generation control section shown in FIG. 4;

FIG. 8 is a diagram showing an example of the number of output pulses from a write strategy section shown in FIG. 7;

FIG. 9 is a diagram showing an example of a mark recorded on a master and an example of laser output pulses;

FIG. 10 is a diagram showing an example of another mark recorded on a master and an example of pulses supplied to a laser;

FIG. 11 is a diagram showing a configuration example of a laser device;

FIGS. 12A to 12D are diagrams showing a relationship between drive current supplied to a laser device and an output pulse from the laser device between the conventional art and the present invention in a comparison manner; and

FIG. 13 is a diagram showing one example of a measurement result of a relaxation oscillation waveform obtained by a semiconductor laser where a resonator length is 650 μm.

### DETAILED DESCRIPTION

Various embodiments according to the invention will be described hereinafter with reference to the accompanying drawings.

An object of the embodiments is to provide a master recording apparatus and method where a master has a symmetrical pit shape and pits can be formed with excellent reproducibility.

According to one aspect of the present invention, there is provided a master recording apparatus where a resist film on a master for an optical disk is irradiated with irradiation light of a semiconductor laser to record information, wherein the resist film is formed as an inorganic resist film, and means for outputting the irradiation light of the semiconductor laser as short pulse laser beam having a pulse width between 200 ps and 1 ns is provided. Thereby, a master having an excellent pit shape symmetrical in a track direction can be manufactured.

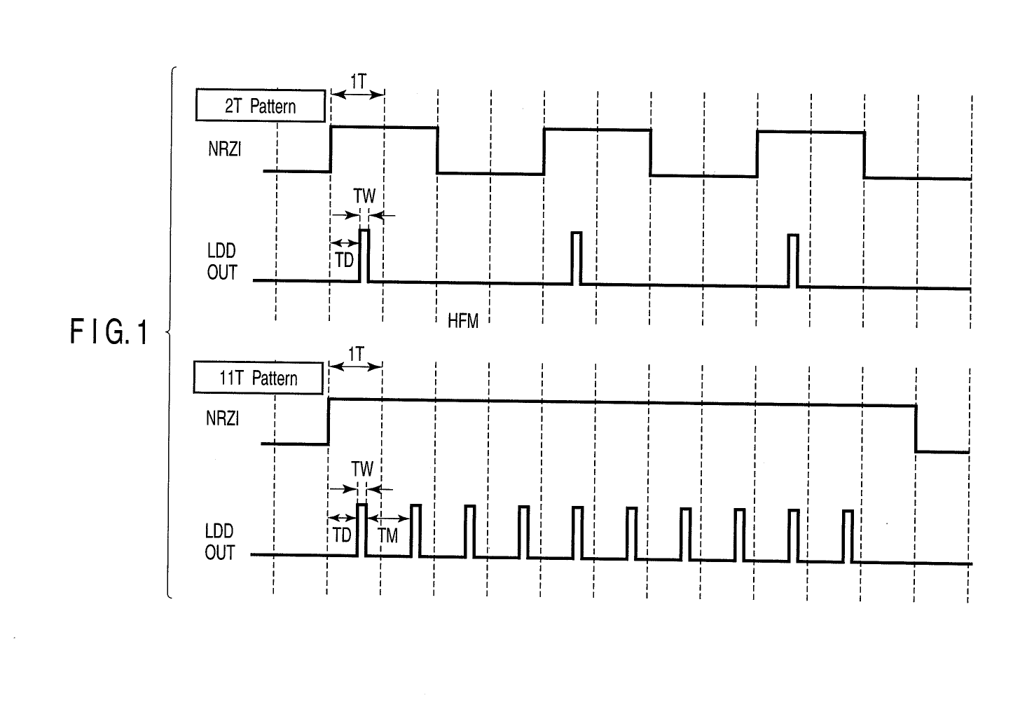

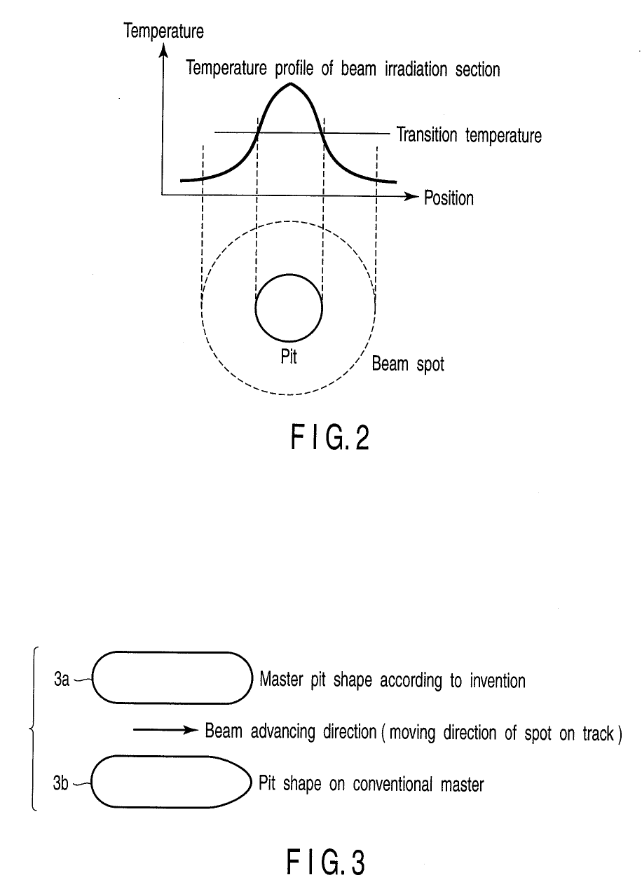

FIG. 1 is an illustration diagram showing a relationship between a record pattern and a laser diode output pulse for explaining a recording method in a master recording apparatus according to the present invention. FIG. 2 is an illustration diagram showing a relationship between a beam spot and a temperature profile of a beam irradiation section for explaining an operation of the master recording apparatus according to the present invention. FIG. 3 is a pattern diagram showing a pit shape on a master obtained according to a conventional method and a pit shape on a master obtained by the method according to the present invention in a comparison manner.

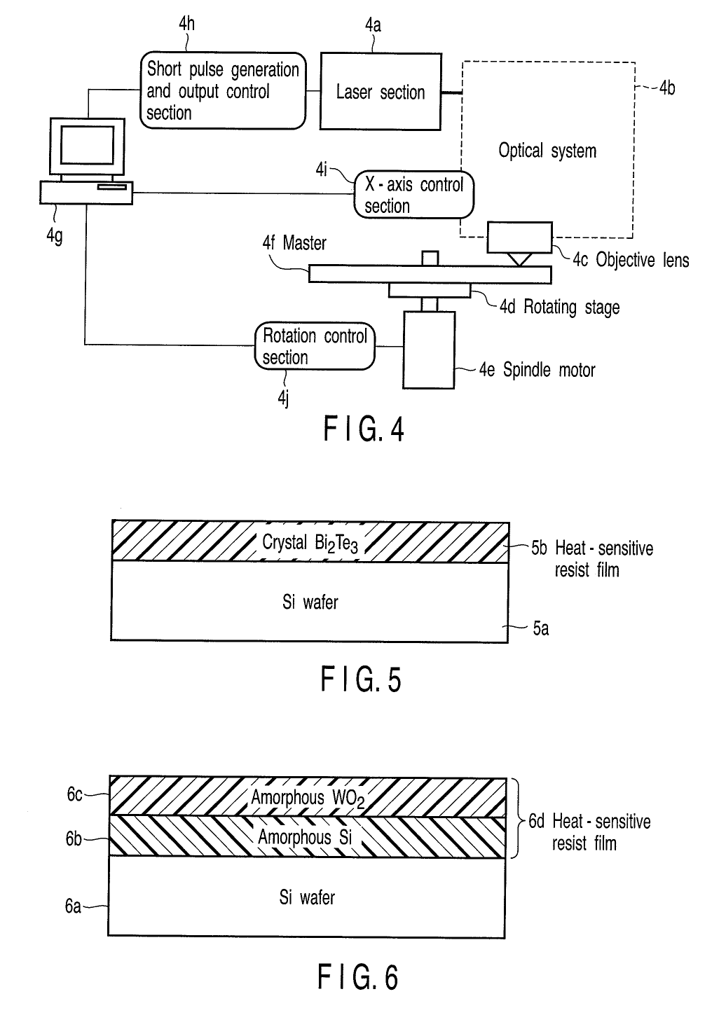

The master recording apparatus according to the present invention shown in FIG. 4 will be explained. In FIG. 4, the feature lies in that information is recorded on a master for an optical disk utilizing heat of semiconductor laser irradiation and a resist film on which information is recorded by laser irradiation is made from at least one selected from a group consisting of Ge, Sb, Te, Bi, Ga, and In, or made from oxide comprising at least one selected from a group consisting of W, Mo, Ta, and Nb, and the feature lies in that information is recorded by irradiation of short pulse laser with a pulse width between 200 ps and 1 ns during recording.

In order to manufacture a master for a play-only optical disk, a heat-sensitive inorganic resist film is formed on a glass substrate or an Si substrate. In the master recording apparatus according to the present invention, at least one selected from a group consisting of Ge, Sb, Te, Bi, Ga, and In, or oxide comprising at least one selected from a group consisting of W, Mo, Ta, and Nb is formed on the substrate to have a film thickness between 10 and 200 nm as the heat-sensitive resist film by a conventional physical vapor deposition method (typically, a RF magnetron sputter method or a DC magnetron sputter method).

Since thermophysical properties such as thermal conductivity or thermal capacity are important for the heat-sensitive resist film, an intermediate layer may be inserted between the substrate and the resist film in order to control heat conduction. In this case, it is more effective to insert an intermediate layer having a low thermal conductivity in order to raise a heat sensitivity of the resist film. As materials for the intermediate layer having a low thermal conductivity, there are Si, various silicides, SiO₂, ZnS, and their compounds. By changing film formation conditions or a film thickness of the intermediate layer, it is made possible to adjust the heat sensitivity of the resist film. It is desirable that a thickness of the intermediate layer is 200 nm or less considering suppression of peeling-off of the resist film from the substrate due to internal stress. Thus, the resist film according to the present invention comprises one layer or two layers made from inorganic material and having a total film thickness of 400 nm or less.

Next, the master recording method in the master recording apparatus according to the present invention will be explained. The resist film is irradiated with short pulses with an output of 10 mW and a pulse width of 200 ps to 1 ns in a multi-pulse manner in order to record digital information as pits.

At this time, as shown in FIG. 1, a shot pit such as 2T is formed by irradiation of one short pulse, while a long pit such as 11T is formed by irradiation of a plurality of short pulses. 2T corresponds to a channel bit length comprising two continuous “1”. In order to form smaller pits to achieve a large capacity, it is necessary to combine laser with a short wavelength and a high NA lens as much as possible, but fine pits exceeding an optical limit can be formed thermally using the heat-sensitive resist film.

That is, as shown in FIG. 2, a part of the laser irradiation portion where a temperature has been raised to a transition temperature of the resist film is small regarding a region. Therefore, a part smaller than a beam diameter, which is determined according to optical conditions (mainly, wavelength and objective lens NA) can be metamorphosed in a relaxation manner, which can result in formation of fine pits.

After recording on the resist film is terminated, developing to a product is performed using conventional alkaline developer having a pH value approximately between 12 and 14 which is also used in the current master recording.

When chalcogen material typified by Ge, Sb, or Te contained in the abovementioned resist materials is used at the abovementioned step, material having a low crystallization temperature (about 120° C.), such as Sb₂Te₃ or Bi₂Te₃ is crystallized at a film formation time. When the material is irradiated with laser beam for recording, it is made amorphous so that only a non-irradiated portion (crystal) is eluted into alkaline solution. However, material having a high crystallization temperature (about 180° C.) such as GeTe becomes amorphous at a film formation time. When the material is irradiated with laser beam for recording, it is crystallized and only an irradiation portion (crystal) is eluted into alkaline solution. Similarly, even when transition metal oxide typified by W or Mo is used, a different reaction occurs according to kind of material or a film forming method. For example, when WO3 is used, a metamorphosed portion obtained by beam irradiation is eluted into alkaline solution but a non-irradiated portion is insoluble, while, when WO2 is used, a metamorphosed portion is insoluble but a non-irradiated portion is eluted into alkaline solution. Further, in a case of W oxide, reaction to alkaline is different between a case where reactive DC sputter is performed in mixed gas of oxygen and argon and a case that ordinary DC sputter is performed. Even when any of the materials described above and any of the film forming methods described above are used, development can be performed utilizing a difference in solubility to alkaline between the beam-irradiation portion and the non-irradiated portion.

Pits on a master for an optical disk manufactured using the resist material and the recording method according to the present invention were observed utilizing atomic force microscopy (AFM). A pattern diagram showing a pit shape on a master according a conventional method and a pit shape on a master according to the present invention for comparison is shown in FIG. 3. A pit 3b on conventional master takes a shape where a mark end portion extends in a beam advancing direction so that the pit shape becomes asymmetric but a pit 3a on a master according to the present invention take a symmetric shape in a beam advancing direction. The pit shape on the master is reflected in a pit shape on an optical disk which is a final shape so that symmetrical property influences characteristics of the optical disk. It is made possible to manufacture a master having pits excellent in symmetrical property by using the master recording apparatus and the master recording method according to the present invention.

FIG. 4 is a schematic diagram of the master recording apparatus according to the present invention. The master recording apparatus according to the present invention comprises a laser section 4a, an optical system 4b for guiding laser light up to an objective lens, an objective lens 4c, a rotating stage 4d, a spindle motor 4e, a master 4f, and a computer 4g which controls these members. The computer 4g controls a short pulse generation and output control section 4h, an X-axis control section 4i, a rotation control section 4j, and the like. The short pulse generation and output control section 4h supplies pulses to the laser section 4a according to record information. The X-axis control section 4i controls a movement position of the optical system 4b according to a record position (a record track). The rotation control section 4j stabilizes rotation of the spindle motor 4e and controls the spindle motor 4e so as to rotate according to record information.

Where, the short pulse generation and output control section 4h works as a control module which controls the irradiation light from the semiconductor laser as a short pulse laser with a pulse width between 200 ps and 1 ns.

A glass or Si substrate on which a heat-sensitive resist film has been formed according to the present invention is placed on the rotating stage. The heat-sensitive resist film is formed on the substrate by a sputter apparatus in advance.

Laser which makes it possible to generate short pulses with a pulse width of 1 ns or less utilizing relaxation oscillation of a semiconductor laser is focused on a surface of a master while output control is performed, and information to be recorded from the computer is formed in pulses with a width between 200 ps and less than 1 ns to be recorded on the resist film. A pit shape on a master for an optical disk manufactured by such a master recording apparatus and recording method shows excellent symmetrical properties like the pit 3a shown in FIG. 3.

### EXAMPLES

Specific examples of the present invention are shown below and the present invention will be explained more specifically.

### Example 1

Bi₂Te₃ was formed on an Si wafer 5a with a diameter of 8 inches and a thickness of 0.7 mm as a 80 nm heat-sensitive resist film 5b by DC magnetron sputter method (see FIG. 5). The Bi₂Te₃ film was crystallized just after film formation, and information was recorded on the Bi₂Te₃ film utilizing short pulses with a pulse width 300 ps and a peak current of 120 mA obtained by relaxation oscillation. At this time, the record portion was made amorphous. For example, recording was performed by conducting irradiation of (n-1) short pulses to an arbitrary mark length nT. Recording conditions are as shown in TABLE 1. After the recorded wafer was immersed for 120 seconds in a vessel containing inorganic alkaline developer with pH 12.7, it was cleaned using pure water. When a wafer surface was observed by AFM, it was found that a record pit showed an etching behavior of a negative type where a non-record portion where a record pit remained as a projection portion was eluted.

Nickel was DC-sputtered on the wafer surface after etched to have a thickness of 40 nm, the wafer was immersed in nickel sulfanate aqueous solution, a predetermined current voltage was applied to the wafer using the wafer as a negative electrode, and precipitation of nickel was awaited. A nickel foil with a thickness of 250 μm was precipitated after about 1 hour and it was peeled off. Such a fact that a record pit was transferred on the nickel stamper peeled off as a recess was confirmed by AFM observation. When both ends of 11T mark having the longest mark length were observed, both the ends were formed in semi-circular shapes having the same curvature and had a depth of 65 nm (see the pit 3a in FIG. 3).

Thus, it was found that a stamper obtained from the master manufactured by the master recording apparatus and method according to the present invention had a symmetrical pit shape. After a PC substrate with a thickness of 0.6 mm was molded using the stamper, an HD DVD-ROM-compliant optical disk with a thickness of 1.2 mm was formed by forming a reflecting layer and applying PC with a thickness of 0.6 mm thereon. As the result that the optical disk having about 30 GB as a recording capacity was evaluated by an evaluating apparatus ODU-1000, SbER and PRSNR which were evaluation indexes for HD DVD showed 7.6×10⁻⁷ and 28, respectively. Both satisfy SbER<5×10⁻⁵ and PRSNR>15 which are HD DVD Standard. As described above, it was clarified that an optical disk with a recording capacity of 30 GB could be manufactured without depending on the optical limit due to a wavelength and NA by using the master recording apparatus and recording method according to the present invention.

### Example 2

GeTe was formed on an Si wafer as an 80-nm heat-sensitive resist film under conditions similar to those in Example 1 and using a method similar to that in Example 1. The GeTe film after formed was amorphous and when recording was performed under the same recording conditions as those in Example 1, a record portion was made amorphous. When development was performed under the same conditions as those in Example 1, an etching behavior of a positive type where the record portion was eluted so that a recessed pit remained were obtained. Thereafter, steps from a stamper manufacturing step to a disk manufacturing step were performed under the same conditions as those in Example 1. When projection pits transferred to a stamper were observed by AFM, symmetrical pits similar to those in Example 1 were observed. As the result of evaluation of the optical disk obtained performed by an evaluating apparatus ODU-1000, SbER and PRSNR which were evaluation indexes for an HD DVD showed 5.2×10⁻⁷ and 30, respectively. Both satisfied SbER<5×10⁻⁵ and PRSNR>15 which were HD DVD Standard. As described above, even when GeTe was used as the heat-sensitive resist material, it was clarified that an optical disk with a recording capacity of 30 GB could be manufactured without depending on the optical limit due to a wavelength and NA by using the master recording apparatus and recording method according to the present invention.

### Example 3

A heat-sensitive resist layer 6d was provided on an Si wafer by sequentially forming an Si layer 6b with a thickness of 80 nm and a WO2 layer 6c with a thickness of 80 nm on the wafer 6a under the same conditions as those in Example 1 by the same method as that in Example 1 (FIG. 6). The WO2 film after formed was amorphous and it was crystallized when information was recorded on the WO2 layer 6c utilizing short pulses with a pulse width 990 ps and a peak current of 105 mA obtained by relaxation oscillation. When development was performed under the same conditions as those in Example 1, an etching behavior of a positive type where the record portion was eluted so that recessed pits remained was shown. Thereafter, steps from a stamper manufacturing step to a disk manufacturing step were performed under the same conditions as those in Example 1. When projection pits transferred to a stamper were observed by AFM, symmetrical pits similar to those in Example 1 were observed. As the result of evaluation of the optical disk obtained performed by an evaluating apparatus ODU-1000, SbER and PRSNR which were evaluation indexes for an HD DVD showed 1.4×10⁻⁶ and 24, respectively. Both satisfied SbER<5×10⁻⁵ and PRSNR>15 which were HD DVD Standard. As described above, even when Si/WO2 was used as the heat-sensitive resist material, it was clarified that an optical disk with a recording capacity of 30 GB could be manufactured without depending on the optical limit due to a wavelength and NA by using the master recording apparatus and recording method according to the present invention.

### Example 4

An Si film with a thickness of 70 nm was formed on an Si wafer with a diameter of 8 inches and a thickness of 0.7 mm by DC magnetron sputter method and a WO_{2.5} film with a thickness of 95 nm was then formed thereon using W (tungsten) target by reactive DC sputter method using mixed gas of argon and oxygen. The WO_{2.5} film after formed was crystalline and it was made amorphous when information was recorded on the WO_{2.5} film utilizing short pulses with a pulse width of 990 ps and a peak current of 105 mA obtained by relaxation oscillation. When development was performed under the same conditions as those in Example 1, an etching behavior of a negative type where the non-record portion was eluted so that projection pits remained was shown. Thereafter, steps from a stamper manufacturing step to a disk manufacturing step were performed under the same conditions as those in Example 1. When recessed pits transferred to a stamper were observed by AFM, symmetrical pits similar to those in Example 1 were observed. As the result of evaluation of the optical disk obtained performed by an evaluating apparatus ODU-1000, SbER and PRSNR which were evaluation indexes for an HD DVD showed 2.3×10⁻⁶ and 21, respectively. Both satisfied SbER<5×10⁻⁵ and PRSNR>15 which were HD DVD Standard. As described above, even when Si/WO_{2.5} was used as the heat-sensitive resist material, it was clarified that an optical disk with a recording capacity of 30 GB could be manufactured without depending on the optical limit due to a wavelength and NA by using the master recording apparatus and recording method according to the present invention.

TABLE 1

| | | |
|---|---|---|
| Wavelength | 405 | nm |
| Objective Lens | 0.95 | |
| Recording Pitch | 0.30 | μm |
| Shortest Mark Length | 0.137 | μm |
| Linear Speed | 4.42 | m/s |

Next, an information recording system for performing beam irradiation to a master utilizing relaxation oscillation (information recording processing) when information is recorded on a master will be additionally explained. The apparatus can be understood in a same manner as a partial configuration of a DVD or HD DVD recording and reproducing apparatus. Accordingly, explanation is made while showing a part of a control method of a recording and reproducing apparatus.

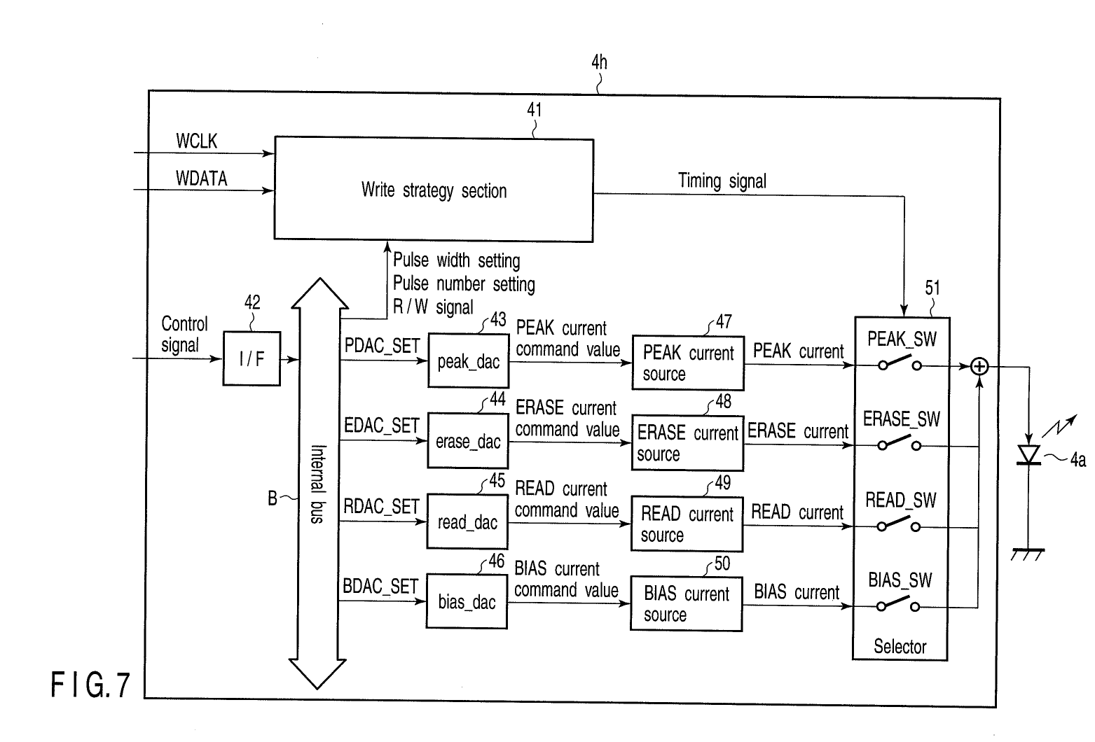

FIG. 7 is a block diagram showing a configuration of a short pulse generation and output control section 4h in the master recording apparatus. The abovementioned laser section 4a for short wavelength is used as a light source. A wavelength of emitted light falls in a violet wavelength band in a range between 400 and 410 nm, for example.

Emission light from the laser section 4a is collimated to parallel light by, for example, a collimating lens in the optical system 4b to pass through a polarization beam splitter and a λ/4 plate. Then, the light enters the objective lens 4c. Thereafter, the light is focused on the resist film on the master 4f.

The objective lens 4c can be driven in up and down directions and a disk radial direction by an actuator, and it is controlled so as to follow a track on the master by a servo driver.

A light amount of emission light from the laser section 4a can be controlled by the short pulse generation and output control section 4h, where control can be performed such that relaxation oscillation pulses are emitted from the laser section 4a at a recording time of information on the master. The short pulse generation and output control section 4h is controlled by the computer 4g. A recording pulse at the recording time of information to the master will be explained in detail later.

The short pulse generation and output control section 4h includes a write strategy section 41 which receives a control signal from the computer 4g and stores therein write strategy information used at a record processing time of a peak current value, a pulse width, and the like, and an interface section 42 which receives a control signal from the computer 4g. The short pulse generation and output control section 4h includes a peak digital-to-analog converter 43 input with a peak current command value in a form of a digital signal, an erase digital-to-analog converter 44 input with an erase current command value in a form of a digital signal, a read digital-to-analog converter 45 input with a read current command value in a form of a digital signal, and a bias digital-to-analog converter 46 input with a bias current command value in a form of a digital signal.

Further, the short pulse generation and output control section 4h includes a peak current source 47 supplying peak current according to a peak current command value from the peak digital-to-analog converter 43, an erase current source 48 outputting erase current according to an erase current command value from the erase digital-to-analog converter 44, a read current source 49 outputting read current according to a read current command value from the read digital-to-analog converter 45, and a bias current source 50 outputting bias current according to a bias current command value from the bias digital-to-analog converter 46. A selector 51 selects one of currents from the respective current sources to supply the selected one to the laser section 4a in the subsequent stage according to a timing signal provided.

Incidentally, configurations of the respective sections are connected to an internal bus B for performing transmission and reception of data.

(Recording processing according to relaxation oscillation and the number of pulses corresponding to a record mark length [heat-sensitive recording section])

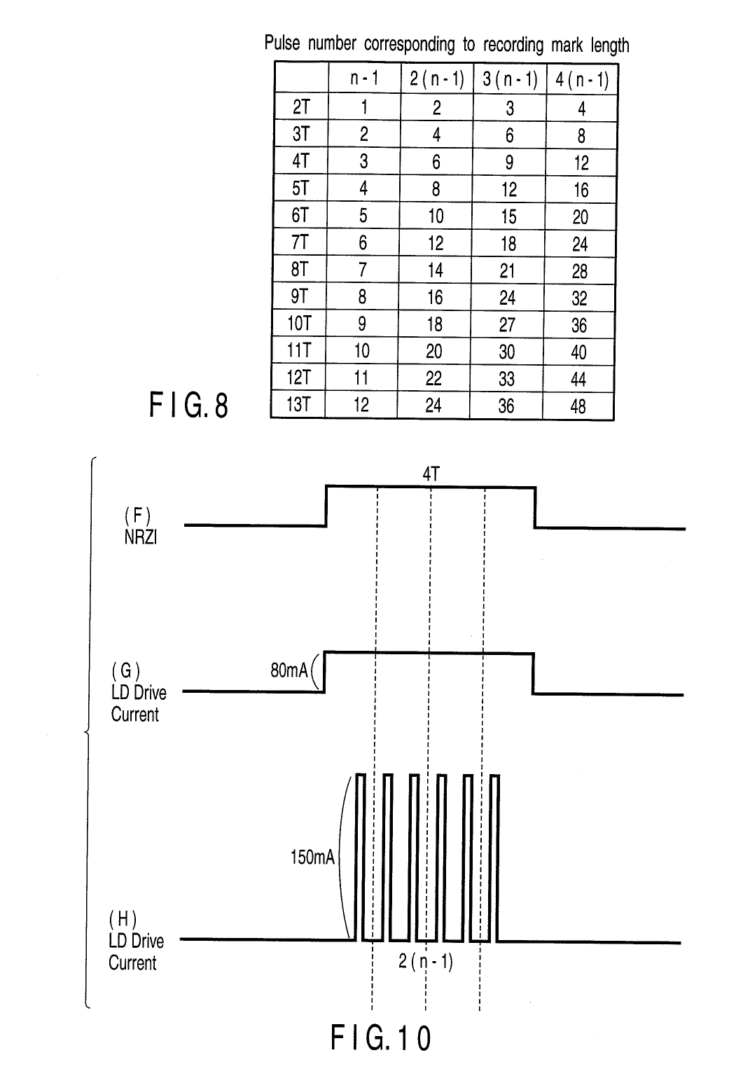

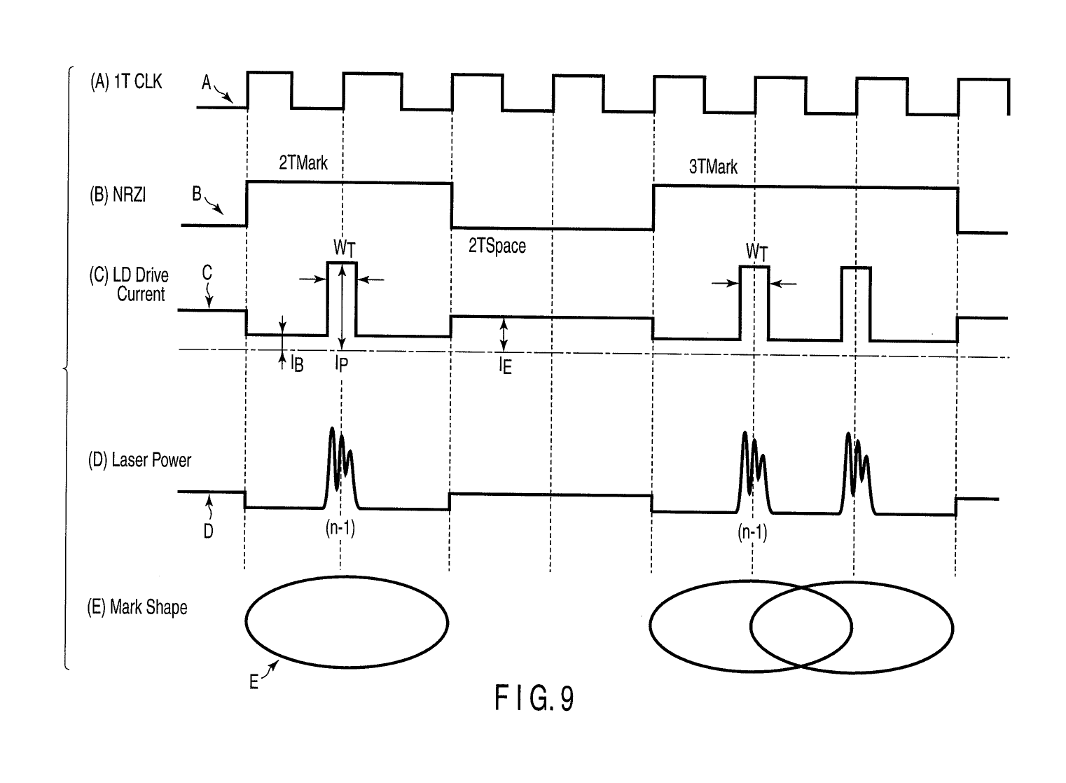

Next, in the master recording apparatus, the number of short pulses according to a proper relaxation oscillation corresponding to a record mark length nT will be explained below with reference to the drawings. FIG. 8 is an illustration diagram showing one example of the number of pulses corresponding to a record mark length. FIG. 9 is a timing chart showing one form of respective signals when a 2T mark and a 3T mark are formed, and FIG. 10 is a timing chart showing one form when a 4T mark of a master recording apparatus is formed similarly.

In FIG. 9, A shows a clock of a 1T cycle, and B shows an NRZI pulse waveform for a 2T mark, a 2T space, and a 3T mark. In FIG. 9, C shows the drive current of a laser diode, D shows the power output of laser light, and E shows a mark shape. When the 2T mark shown in B and E is formed, one pulse shown in C is supplied from the short pulse generation and output control section 4h to the laser section 4a. Here, a pulse width WT, a peak current IP, a bias current IB, and an erase current IE are shown.

The number of recording pulses at this time is determined at the write strategy section 41 shown in FIG. 7. As shown in the illustration diagram in FIG. 8, the number of pulses to the record mark length nT to be recorded on an optical disk (n: integer, and T: channel clock) is represented by N(n-1) (N is an integer)

When the mark length is “2T”, the number of pulses is “1”. However, such a case that 2(n−1)=2, 3(n−1)=3, or 4(n−1)=4 is proper occurs according to various conditions such as the number of multiple speeds, material, or the like.

In order to form a 3T mark shown by B in FIG. 9 and E in FIG. 9, two pulses are supplied from the short pulse generation and output control section 4h to the laser section 4a. Laser light emitted from the laser section 4a shows a very precipitous power in a pulse shape as shown by D in FIG. 9, and laser light having relaxation oscillation is output twice.

When the mark length is “3T”, the number of pulses determined at the write strategy section 41 is “2”. As shown in FIG. 8, however, such a case that an adequate number of pulses are 4, 6, or 8 occurs according to the various conditions such as the number of multiple speeds, material, or the like. The number of recording pulses is determined according to the abovementioned rule.

In FIG. 10, F to H show a case (G in FIG. 10) that laser light is emitted by providing conventional recording pulse (drive current) from the short pulses generation and output control section 4h in order to form an approximate 4T mark length (F in FIG. 10) and a case (F in FIG. 10) that laser light accompanying relaxation oscillation is emitted by providing precipitous recording pulses (drive current) in the present invention in a comparison manner.

The case that the number of pulses at this time is (4−1)×2=6, where N=2, is shown.

As can be understood from the waveform, the relaxation oscillation system can conduct a recording processing equivalent to that in the conventional method with very small energy such as about ⅕ of the energy required in the conventional method regarding power consumption.

When the shortest record mark length based upon a predetermined record modulation system to the record mark length nT is nmᵢₙ T (nₘᵢₙ is an integer), it is desirable that a relationship between a wavelength λ of laser light from the laser section 4a and the numerical aperture NA of the objective lens 4c for focusing laser light satisfies

λ/(4×NA)≦nmᵢₙT≦λ/(2.5×NA).

It is desirable that the track pitch TP provided on the optical disk satisfies the condition of

λ/(2×NA)≦TP≦λ/(1.3×NA).

That is, when sufficiently high density to the beam spot diameter which can be utilized is achieved, further effect can be achieved.

(Semiconductor Chip Portion Used for the Semiconductor Laser Section 4a)

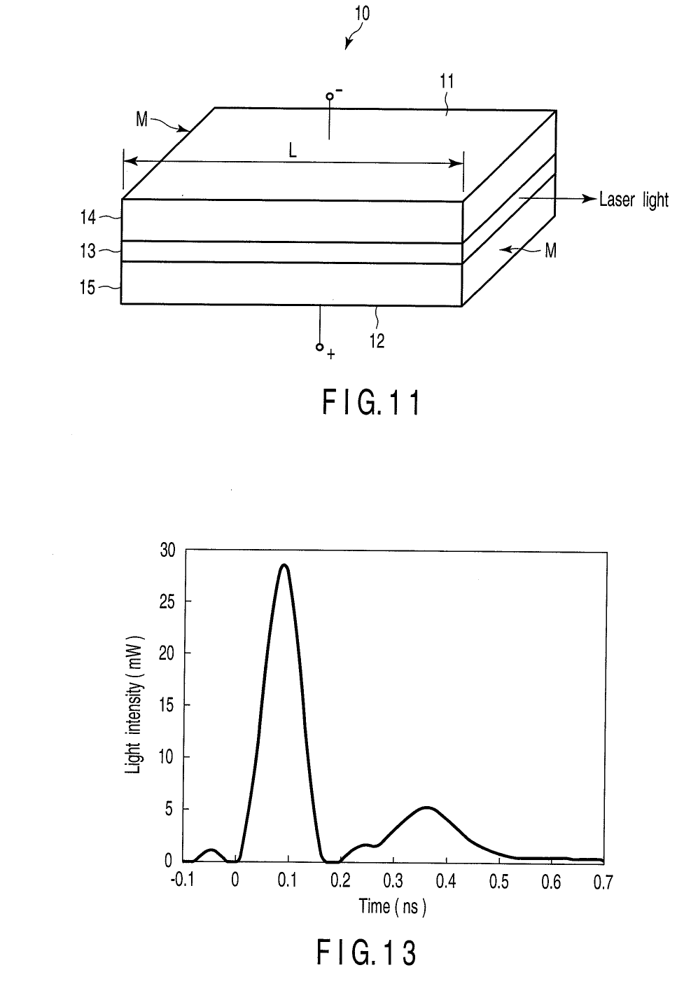

Next, a semiconductor chip portion which is a part of a light source used in the master recording apparatus will be explained. FIG. 11 shows only a semiconductor chip portion 10 serving as a light emitting body of a semiconductor laser. The semiconductor chip portion 10 is generally fixed to a metal block serving as a heat sink and it comprises a base member, a cap provided with a glass window, and the like.

The semiconductor chip portion 10 is a fine block having a thickness (a vertical direction on in-plane in FIG. 11) of 0.15 mm, a length (L in FIG. 11) of 0.5 mm, and a lateral width (depth direction in FIG. 11) of about 0.2 mm as one example. The laser chip includes an upper end electrode 11 and a lower end electrode 12, where the upper end electrode 11 is a negative (−) electrode while the lower end electrode 12 is a positive (+) electrode.

A central active layer 13 emits laser light, and an upper side cladding layer 14 and a lower side cladding layer 15 are formed so as to sandwich the central active layer 13 from above and beneath. The upper side cladding layer 14 is an n type cladding layer including a lot of electrons, while the lower side cladding layer 15 is a p type cladding layer including a lot of holes.

Voltage is applied between the lower end electrode 12 and the upper end electrode 11 from the lower end electrode 12 to the upper end electrode 11 in a forward direction. That is, when current is caused to flow from the lower end electrode 12 toward the upper end electrode 11, a lot of holes and a lot of electrons excited in the active layer 13 rejoin so that light corresponding to energy lost at the rejoining time is discharged. Materials are selected such that the refractive indexes of the upper side cladding layer 14 and the lower side cladding layer 15 become lower than the refractive index of the active layer 13 (the former are lower than the latter by 5% as one example), where light generated in the active layer 13 configures light wave advancing within the active layer 13 in left and right directions in FIG. 11 while it is being reflected at a boundary with the upper side cladding layer 14 and a boundary with the lower side cladding layer 15.

In FIG. 11, left and right end surfaces configure mirror surfaces M, and the active layer 13 itself forms a light resonator. The light wave which has advanced within the active layer 13 in left and right directions and has been reflected by the mirror surfaces at both the left and right ends is amplified within the active layer 13 and it is finally discharged at the right end (and the left end) in FIG. 11 as a laser light. At this time, the resonator length of the laser section 4a is a length L in a horizontal direction in FIG. 11.

An emission wavelength from the laser section 4a is controlled by drive current generated by the short pulse generation and output control section 4h. An aspect where a recording pulse used for recording on a master is generated by drive current from the short pulse generation and output control section 4h will be explained.

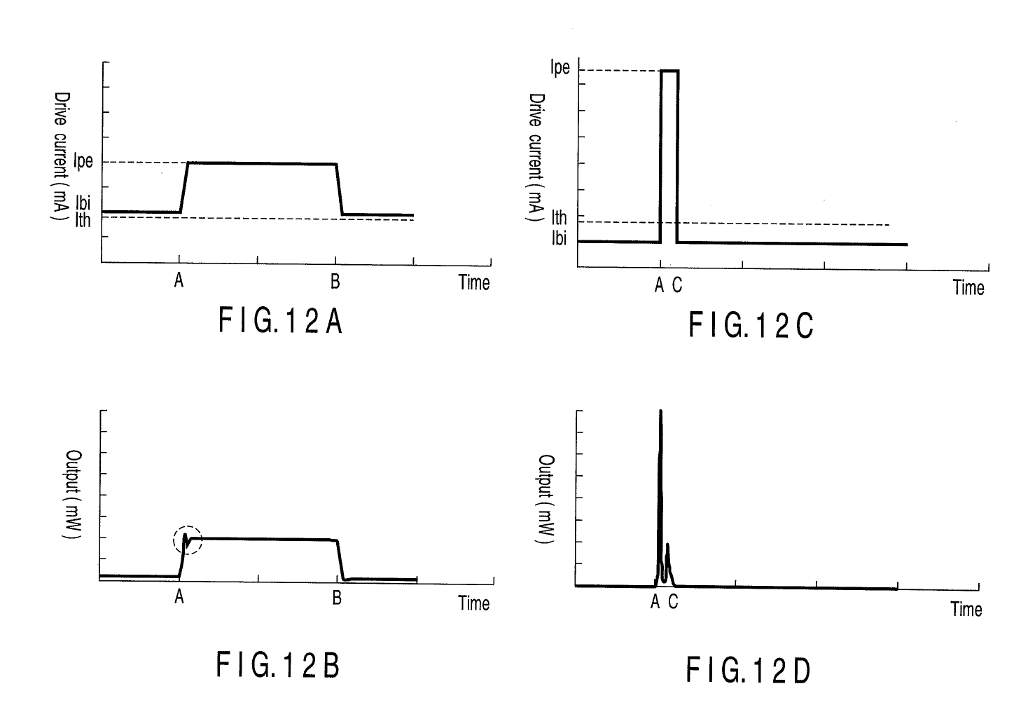

FIGS. 12A and 12B represent a conventional semiconductor laser drive current and a conventional semiconductor laser emission waveform, while FIGS. 12C and 12D represent a semiconductor laser drive current and a semiconductor laser emission waveform when a relaxation oscillation pulse is produced.

The drive current is controlled to two levels of a bias current Ibi and a peak current Ipe shown in FIGS. 12A and 12C. Incidentally, there is such a case that the bias current is further subdivided to two levels or three levels to be controlled. Here, however, explanation is made using a case that the bias current Ibi and the peak current Ipe each take one level for simplification of explanation.

In an ordinary recording pulse production, as shown in FIG. 12A, the short pulse generation and output control section 4h first produces bias current Ibi set to a level slightly higher than threshold current Ith at which the laser section 4a starts laser oscillation to drive the laser section 4a. Thereafter, a peak current Ipe for obtaining desired peak power is applied to the laser section 4a at a time A, and after application of the peak current Ipe is performed for a fixed time, lowed down to the bias current Ibi is performed at a time B again. A change of an emission light intensity from the laser section 4a over time is shown in FIG. 12B.

As shown in FIG. 12B, the emission light intensity is kept at extremely low power where data recording on a master is impossible by the time A, the laser portion 4a being driven by the bias current Ibi before the time A, the intensity is raised up to the recording power along application of the peak current Ipe, and this power level is maintained until the drive current is lowed down to the bias current Ibi level at the time B. The emission light intensity lowers to low power after the time B, again. The laser section 4a is controlled such that recording pulses are emitted for a period of time from the time A to the time B.

When the emission light intensity is observed more specifically, such an aspect can be known that, when the intensity is raised up to the recording power at the time A, the intensity rises and lowers instantaneously until the recording power is stabilized to a steady recording power (a part circled a broken line in FIG. 12B). This is due to relaxation oscillation of the laser section 4a, and control is performed in an ordinary recording pulse production such that the relaxation oscillation becomes small as far as possible.

Thus, the relaxation oscillation is a relaxation oscillation phenomenon occurring when drive current rapidly rises from a certain level up to a fixed level exceeding the threshold current largely in a semiconductor laser. The relaxation oscillation becomes smaller according to repetition of oscillations and it converges before long.

In the master recording apparatus according to the present embodiment, the relaxation oscillation is positively utilized for recording. When the relaxation oscillation is used as recording pulses, as shown in FIG. 12C, the short pulse generation and output control section 4h first produces bias current Ibi set at a level lower than the threshold current Ith of the laser section 4a to drive the laser section 4a.

Thereafter, the drive current is abruptly raised up to the peak current level Ipe with a rise time faster than an ordinary recording pulse production at the time A, and the drive current is lowered down to the bias current Ibi after a time shorter than the ordinary recording pulse production at the time C, again. A change of emission light intensity of the laser section 4a over time at this time is shown in FIG. 12D.

As shown in FIG. 12D, the laser section 4a does not start laser oscillation by the time A, the laser section 4a being driven with the bias current Ibi lower than the threshold current Ith before the time A, where the laser section 4a only emits light in a negligible level as a light emitting diode. Thereafter, the relaxation oscillation is started according to abrupt current application at the time A, so that the light emission intensity rapidly rises. Thereafter, light emission according to the relaxation oscillation is maintained by the time C at which the application current is returned back to the threshold current or less again. In this example, the time C is reached at a timing at which the second cycle pulse of the relaxation oscillation has been produced so that the recording pulse production is terminated.

Thus, a feature of the pulses according to the relaxation oscillation lies in that the emission light intensity rises in a very short time, as compared with the ordinary recording pulse, and the emission light intensity lowers in a fixed cycle determined according to the structure of the semiconductor laser. Accordingly, by using pulses according to the relaxation oscillation as recording pulses, it is made possible to obtain short pulses having short rise and fall times and having high peak intensity which cannot be obtained in the ordinary recording pulses.

As the commonly known relationship, the following relationship is found between the resonator length L and the relaxation oscillation cycle T.

T=k·{2nL/c} (1)

Here, k is a constant, n is refractive index of an active layer of a semiconductor laser, and c is the speed of light (3.0×10⁸ m/s). Therefore, it is found that the resonator length L and the relaxation oscillation cycle T, therefore, the relaxation oscillation pulse width lie in a proportional relationship.

From the above, when the relaxation oscillation pulse width should be elongated, the resonator length L can be extended, and when the relaxation oscillation pulse width should be reduced, the resonator length L can be shortened. That is, it can be said that the relaxation oscillation pulse width can be controlled by the resonator length L.

FIG. 13 shows a measurement result of a relaxation oscillation waveform obtained by a semiconductor laser where its resonator length L is 650 μm. It is found that the relaxation oscillation pulse width is 81 ps at full width at half maximum. Since it is found from the abovementioned equation (1) that the resonator length L and the relaxation oscillation pulse width L are in a proportional relationship, the following relationship can be obtained as a conversion equation between the resonator length L of the semiconductor laser and the relaxation oscillation pulse width (FWHM)Wr obtained.

Wr [ps]=L [μm]/8.0 [μm/ps] (2)

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A master recording apparatus comprising:
a resist film on a master optical disk; and
a semiconductor laser configured to irradiate the resist film with light, and to record information on the resist film, wherein
the resist film is an inorganic film, and a controller is configured to control a pulse width of the light from the semiconductor laser between 200 ps and 1 ns.

2. The master recording apparatus of claim 1, wherein the resist film is made from at least one material selected from the group consisting of Ge, Sb, Te, Bi, Ga, and In.

3. The master recording apparatus of claim 1, wherein the resist film is made from oxide of at least one material selected from the group consisting of W, Mo, Ta, and Nb.

4. A master recording method comprising:
irradiating light on a resist film on a master optical disk from a semiconductor laser; and
recording information on the resist film, wherein
the resist film is an inorganic film, and the light from the semiconductor laser is with a pulse width between 200 ps and 1 ns.

5. The master recording method of claim 4, wherein the resist film is made from at least one material selected from the group consisting of Ge, Sb, Te, Bi, Ga, and In.

6. The master recording method of claim 4, wherein the resist film is made from oxide of at least one material selected from the group consisting of W, Mo, Ta, and Nb.
